(19) United States
(12) Patent Application Publication
(10) Pub. No.: US 2026/0058893 A1
(43) Pub. Date: Feb. 26, 2026

(54) DISTRIBUTED LINK TRACING DATA PROCESSING METHOD, DEVICE, AND STORAGE MEDIUM

(71) Applicant: Beijing Volcano Engine Technology Co., Ltd., Beijing (CN)

(72) Inventors: Yu XIE, Beijing (CN); Han MIAO, Beijing (CN); Xuyan ZHAO, Beijing (CN)

(21) Appl. No.: 19/221,238

(22) Filed: May 28, 2025

(30) Foreign Application Priority Data
Aug. 20, 2024 (CN) 202411147149.2

(51) Int. Cl. H04L 43/10; H04L 12/46; H04L 45/17

(52) U.S. Cl. CPC H04L 43/10; H04L 12/4633; H04L 45/17

(57) ABSTRACT

Embodiments of the present disclosure relate to a distributed link tracing data processing method, a device, and a storage medium. The method includes: receiving a service request, processing the service request, caching first tracing data generated in a local cache, constructing a sub-request of the service request, delivering the sub-request to a next-hop service node, receiving second tracing data generated by the next-hop service node through processing the sub-request of the service request and fed back through a response message, caching the second tracing data in the local cache, processing the response message, caching third tracing data generated in the local cache, obtaining the first tracing data, the second tracing data, and the third tracing data, splicing the above tracing data to obtain full link tracing data generated by processing the service request, and storing the full link tracing data in a target storage device.

### CROSS-REFERENCE TO RELATED APPLICATION

This application claims priority to Chinese Patent Application No. 202411147149.2 filed on Aug. 20, 2024, the disclosure of which is incorporated herein by reference in its entirety as part of this application.

### TECHNICAL FIELD

The present disclosure relates to the field of data processing, and in particular, to a distributed link tracing data processing method and apparatus, a device, and a storage medium.

### BACKGROUND

Data tracing refers to a process of collecting, monitoring, and analyzing specific data by technical means, and is widely used in the field of data processing, especially for software abnormality location, which can help developers quickly locate a specific step in which an abnormality occurs, thereby improving software system reliability. Because data tracing technology needs to obtain a large amount of tracing data, data transmission, reporting, and analysis occupy a large amount of resources, and in severe cases, timeliness of data tracing analysis is also affected. Therefore, how to perform data tracing efficiently and with low overheads is still a technical problem to be solved at present.

### SUMMARY

To solve the foregoing technical problem or at least partially solve the foregoing technical problem, the present disclosure provides a distributed link tracing data processing method and apparatus, a device, and a storage medium.

According to a first aspect, the embodiments of the present disclosure provide a distributed link tracing data processing method. The method includes:
receiving a service request, processing the service request, and caching first tracing data generated in a local cache, and constructing a sub-request of the service request and delivering the sub-request to a next-hop service node;
receiving second tracing data generated by the next-hop service node through processing the sub-request of the service request and fed back by the next-hop service node through a response message, and caching the second tracing data in the local cache; and
processing the response message and caching third tracing data generated in the local cache, obtaining the first tracing data, the second tracing data, and the third tracing data from the local cache, splicing the first tracing data, the second tracing data, and the third tracing data to obtain full link tracing data generated by processing the service request, and storing the full link tracing data in a target storage device for link abnormality analysis of the service request.

In an optional implementation, the constructing a sub-request of the service request further includes:
constructing the sub-request of the service request, and encapsulating a tracing identification of the service request in the sub-request, in which the tracing identification is delivered with a processing path of the service node, and the tracing identification is used to identify tracing data related to the service request.

In an optional implementation, before the storing the full link tracing data in a target storage device, the method further includes:
determining, based on the full link tracing data, whether processing of the service request meets a timeout condition; and
when it is determined that the processing of the service request meets the timeout condition, storing the full link tracing data in the target storage device.

In an optional implementation, the next-hop service node is an intermediate node that processes the service request, and the second tracing data in the response message includes tracing data generated by the next-hop service node through processing the sub-request of the service request and tracing data generated by another service node after the next-hop service node by processing another sub-request of the service request.

In an optional implementation, the method further includes:
when the response message fed back by the next-hop service node is not received within preset time, reporting an abnormality notification to the target storage device, in which the abnormality notification is used to notify that another tracing data of the service request is lost.

In an optional implementation, the next-hop service node is a terminal service node that processes the service request, and the second tracing data in the response message includes tracing data generated by the terminal service node through processing the sub-request of the service request.

In an optional implementation, the terminal service node is configured to: directly store, in the target storage device, tracing data that is not successfully fed back to an upper-hop service node, in which the tracing data is used to be spliced to obtain the full link tracing data generated by processing the service request.

In an optional implementation, before the caching in the local cache, the method further includes:
encoding and compressing the tracing data based on a first preset mapping table that stores a character string and an encoding symbol that have a corresponding relationship, and then caching encoded and compressed tracing data in the local cache.

In an optional implementation, before the caching in the local cache, the method further includes:
encoding and compressing the tracing data based on a second preset mapping table that stores a character string and an encoding value that have a corresponding relationship, and then caching encoded and compressed tracing data in the local cache, in which the encoding value is obtained by performing encoding processing based on a corresponding character string.

According to a second aspect, the embodiments of the present disclosure provide a distributed link tracing data processing apparatus. The apparatus includes:
a first receiving module, configured to receive a service request, process the service request and cache first tracing data generated in a local cache, and process a sub-request of the service request and deliver the sub-request to a next-hop service node;
a second receiving module, configured to receive second tracing data generated by the next-hop service node through processing the sub-request of the service request and fed back by the next-hop service node through a response message, and cache the second tracing data in the local cache; and
a first storage module, configured to process the response message and cache third tracing data generated in the local cache, obtain the first tracing data, the second tracing data, and the third tracing data from the local cache, splice the first tracing data, the second tracing data, and the third tracing data to obtain full link tracing data generated by processing the service request, and store the full link tracing data in a target storage device for link abnormality analysis of the service request.

According to a third aspect, the embodiments of the present disclosure further provide an electronic device. The electronic device includes: a processor; and a memory, configured to store an instruction executable by the processor. The processor is configured to: read the instruction from the memory, and execute the instruction to implement the distributed link tracing data processing method according to the embodiments of the present disclosure.

In a fourth aspect, the embodiments of the present disclosure further provide a computer-readable storage medium. The storage medium stores a computer program, and the computer program is configured to perform the distributed link tracing data processing method according to the embodiments of the present disclosure.

In a fifth aspect, the present disclosure provides a computer program product. The computer program product includes a computer program/instruction. When the computer program/instruction is executed by a processor, the method described above is implemented.

### BRIEF DESCRIPTION OF DRAWINGS

The above and other features, advantages, and aspects of the embodiments of the present disclosure become more apparent when taken in conjunction with the drawings and with reference to the following specific implementations. Throughout the drawings, the same or similar reference numerals represent the same or similar elements. It should be understood that the drawings are schematic and that parts and elements are not necessarily drawn to scale.

FIG. 1 is a schematic diagram of a process of distributed link tracing data processing according to an embodiment of the present disclosure;

FIG. 2 is a flowchart of a distributed link tracing data processing method according to an embodiment of the present disclosure;

FIG. 3 is a schematic diagram of another process of distributed link tracing data processing according to an embodiment of the present disclosure;

FIG. 4 is a schematic structural diagram of a distributed link tracing data processing apparatus according to an embodiment of the present disclosure; and

FIG. 5 is a schematic structural diagram of a distributed link tracing data processing device according to an embodiment of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be performed in different orders and/or in parallel. In addition, the method implementations may include additional steps and/or omit to perform the illustrated steps. The scope of the present disclosure is not limited in this aspect.

The term “include/comprise” and variations thereof as used herein are open-ended inclusions, that is, “include/comprise but not limited to”. The term “based on” is “based, at least partially, on”. The term “an embodiment” represents “at least one embodiment”; the term “another embodiment” represents “at least one another embodiment”; and the term “some embodiments” represents “at least some embodiments”. Related definitions of other terms are given in the following description.

It should be noted that the concepts of “first” and “second” mentioned in the present disclosure are only used to distinguish between different apparatuses, modules, or units, and are not used to limit the order or interdependence of the functions performed by these apparatuses, modules, or units.

It should be noted that the modifications of “one” and “a plurality of” mentioned in the present disclosure are illustrative rather than limiting, and those skilled in the art should understand that unless the context clearly indicates otherwise, they should be understood as “one or more”.

Names of messages or information exchanged between a plurality of apparatuses in the implementations of the present disclosure are only intended for illustrative purposes, and are not intended to limit a scope of these messages or information.

Distributed link data tracing refers to monitoring and recording every step of data flow in an all-round manner from data processing start to end in a distributed system, to ensure visibility and traceability of data during transmission between a plurality of systems and services, which is extremely important for diagnosing system problems, optimizing a data flow, and ensuring data accuracy.

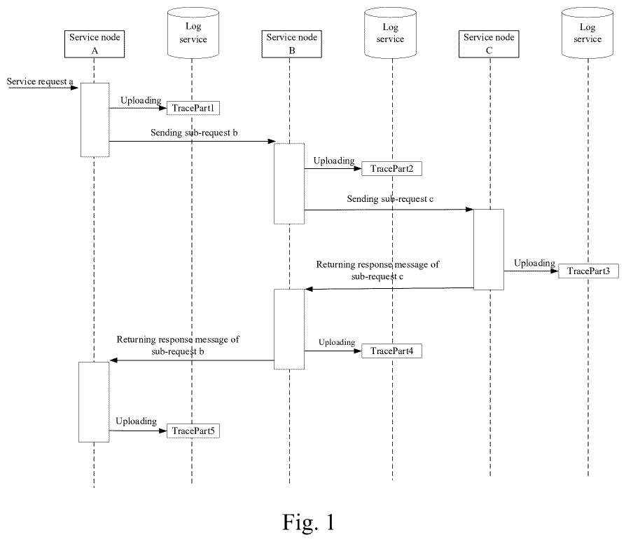

In an implementation, taking a distributed I/O system as an example, FIG. 1 is a schematic diagram of a process of distributed link tracing data processing according to an embodiment of the present disclosure.

It can be learned from FIG. 1 that when receiving a service request a, a service node A, a service node B, and a service node C process the service request a and a sub-request of the service request a, and upload tracing data generated in the processing procedure to a log service separately. That is, each node separately uploads tracing data to the log service, resulting in a high dependence of each node on the log service. How to effectively avoid system design in which each node strongly depends on the log service and implement data tracing for the service request is a technical problem to be solved at present.

For this problem, embodiments of the present disclosure provide a distributed link tracing data processing method. Specifically, a service request is received, the service request is processed and first tracing data generated is cached in a local cache, a sub-request of the service request is constructed and delivered to a next-hop service node, second tracing data generated by the next-hop service node through processing the sub-request of the service request and fed back through a response message is received and cached in the local cache, the response message is processed and third tracing data generated is cached in the local cache, the first tracing data, the second tracing data, and the third tracing data are obtained from the local cache and spliced to obtain full link tracing data generated by processing the service request, and the full link tracing data is stored in a target storage device for link abnormality analysis of the service request.

According to the embodiments of the present disclosure, the first tracing data generated by processing the service request is cached in the local cache, the second tracing data generated by the next-hop service node through processing the sub-request of the service request and fed back through the response message is cached in the local cache, and the third tracing data generated by processing the response message is cached in the local cache, so that the full link tracing data generated by processing the service request is stored in a unified manner at the same node, and the tracing data does not need to be separately uploaded to the log service by each node. Therefore, the system design in which each node strongly depends on the log service is effectively avoided. By using the distributed link tracing data processing method provided in the embodiments of the present disclosure, the data tracing can be performed for the service request, thereby facilitating the quick problem location.

Based on this, an embodiment of the present disclosure provides a distributed link tracing data processing method. The following describes the method with reference to specific embodiments.

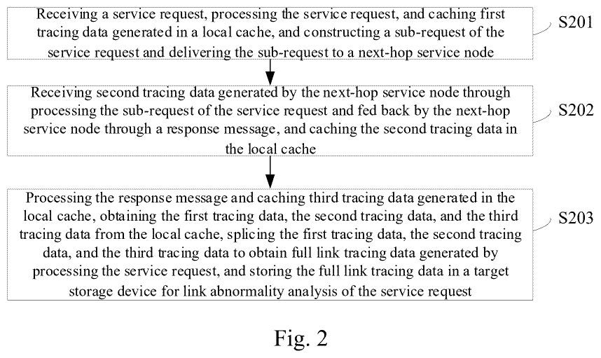

FIG. 2 is a flowchart of a distributed link tracing data processing method according to an embodiment of the present disclosure. The method may be performed by a distributed link tracing data processing apparatus. The apparatus may be implemented by software and/or hardware, and may generally be integrated into an electronic device. As shown in FIG. 2, the method includes the following steps.
S201: receiving a service request, processing the service request and caching first tracing data generated in a local cache, and constructing a sub-request of the service request and delivering the sub-request to a next-hop service node.

The distributed link tracing data processing method provided in the embodiment of the present disclosure may be applied to a distributed system application including at least two service nodes. The processing node may be a relatively independent processing module, an independent process, or the like.

The service request in the embodiment of the present disclosure is a service request received by a start service node. When receiving the service request, the start service node processes the service request and caches first tracing data generated in a processing procedure in the local cache. The first tracing data may include data generated when the start service node processes the service request, for example, a time stamp, and the like.

In an optional implementation, a toolkit is deployed for a current application system. When the service request is received, the toolkit is started to collect related data generated when the service request is processed, and the related data is used as the first tracing data.

In the embodiment of the present disclosure, the first tracing data generated by processing the service request is cached in the local cache based on the obtained first tracing data.

In an optional implementation, a local cache region may be allocated to a current service node, and the local cache region is used to store the first tracing data generated when the current service node processes the service request. The local cache region and the service node have a corresponding relationship. That is, each service node is allocated with a corresponding local cache region.

In the embodiment of the present disclosure, the current start service node processes the service request and caches the first tracing data generated in the local cache, constructs the sub-request of the service request, and sends the sub-request to the next-hop service node. The next-hop service node is a node that processes the sub-request of the service request.

The next-hop service node may include an intermediate node in a processing path of the service node, or may include a terminal service node, that is, an end service node. For content introduction of the next-hop service node being the intermediate node or the terminal service node, refer to the following content for details, and details are not described herein again.

In actual application, because the service node can process a plurality of service requests, to identify a service request to which the tracing data belongs, in the embodiment of the present disclosure, the tracing identification needs to be encapsulated in the sub-request of the service request.

Specifically, the sub-request of the service request is constructed, and the tracing identification of the service request is encapsulated in the sub-request, the tracing identification is delivered with the processing path of the service node, and the tracing identification is used to identify the tracing data related to the service request.

That is, the sub-request of the service request carries the tracing identification, and the tracing identification is used to indicate a service request to which the tracing data generated by the sub-request on the next-hop service node belongs. The tracing data generated by processing the sub-request on the next-hop service node is partial tracing data of the service request on a tracing link.
S202: receiving second tracing data generated by the next-hop service node through processing the sub-request of the service request and fed back by the next-hop service node through a response message, and caching the second tracing data in a local cache.

In the embodiment of the present disclosure, when the response message returned by the next-hop service node is received, the second tracing data generated by the next-hop service node through processing the sub-request of the service request and fed back through the response message may be received. That is, the second tracing data is encapsulated in the response message returned by the next-hop service node to the start service node, and the second tracing data is the tracing data generated by the next-hop service node when the sub-request of the service request is processed. That is, the second tracing data generated by the next-hop service node through processing the sub-request is fed back by the next-hop service node through the response message.

The second tracing data is cached in the local cache based on the obtained second tracing data.
S203: processing the response message and caching third tracing data generated in a local cache, obtaining the first tracing data, the second tracing data, and the third tracing data from the local cache, splicing the first tracing data, the second tracing data, and the third tracing data to obtain full link tracing data generated by processing the service request, and storing the full link tracing data in a target storage device for link abnormality analysis of the service request.

The third tracing data in the embodiment of the present disclosure is tracing data generated by the current start service node by processing a related logical operation based on data in the response message returned by the next-hop service node.

In the embodiment of the present disclosure, the tracing data generated by processing the service request in the entire service node processing path is collected at the start processing node, the first tracing data, the second tracing data, and the third tracing data are obtained from the local cache of the start processing node, and all the foregoing tracing data is spliced to obtain the full link tracing data generated by processing the service request. The full link tracing data of the service request is tracing data generated by processing the service request in a complete processing path. Specifically, the tracing data may be spliced based on a processing sequence of the service request in the processing path of the service node.

The full link tracing data generated by processing the processing request is stored in the target storage device. The full link tracing data is used to locate an abnormality processing node of the service request. The target storage device is configured to store the full link tracing data, and the target storage device may be a device with a storage function, for example, a local disk, a log service platform, or the like.

In an optional implementation, when the target storage device is a local disk, after the full link tracing data generated by processing the service request is stored in the local disk, the full link tracing data in the local disk may be uploaded to the log service for subsequent abnormality location. To facilitate the abnormality location, when the full link tracing data is encoded tracing data, a decoding operation may be performed on the encoded tracing data before the encoded tracing data is uploaded to the log service, and then the tracing data after decoding is uploaded to the log service.

In actual application, to avoid storing the full link tracing data without an abnormality in the target storage device, the embodiment of the present disclosure may further perform data filtering on the full link tracing data generated by processing the service request.

In an optional implementation, the service request is subjected to time delay judgment. Specifically, whether the processing of the service request meets a timeout condition is determined based on the full link tracing data generated by processing the service request. The timeout condition is whether the full link data processing time for processing the service request exceeds a preset time threshold, and the preset time threshold may be a minimum time value at which a timeout occurs.

Specifically, the full link data processing time for processing the service request is obtained from the full link tracing data based on the full link tracing data generated by processing the service request, and whether the full link data processing time meets the preset timeout condition is determined. When it is determined that the full link data processing time meets the timeout condition, that is, the full link data processing time exceeds the preset time threshold, the full link tracing data generated by processing the service request is stored in the target storage device.

The full link data processing time for processing the service request is obtained. Specifically, a start time stamp and an end time stamp for processing the service request may be obtained from the full link tracing data for executing the service request, and a difference between the start time stamp and the end time stamp is calculated to obtain the full link data processing time.

When it is determined that the full link tracing data generated by processing the service request does not meet the timeout condition, that is, the processing time does not exceed the preset time threshold, the full link tracing data generated by processing the service request is discarded.

The embodiments of the present disclosure provide a distributed link tracing data processing method. Specifically, a service request is received, the service request is processed and first tracing data generated is cached in a local cache, a sub-request of the service request is constructed and delivered to a next-hop service node, second tracing data generated by the next-hop service node through processing the sub-request of the service request and fed back through a response message is received and cached in the local cache, the response message is processed and third tracing data generated is cached in the local cache, the first tracing data, the second tracing data, and the third tracing data are obtained from the local cache and spliced to obtain full link tracing data generated by processing the service request, and the full link tracing data is stored in a target storage device for link abnormality analysis of the service request.

According to the embodiments of the present disclosure, the first tracing data generated by processing the service request is cached in the local cache, the second tracing data generated by the next-hop service node through processing the sub-request of the service request and fed back through the response message is cached in the local cache, and the third tracing data generated by processing the response message is cached in the local cache, so that the full link tracing data generated by processing the service request is stored in a unified manner at the same node, and the tracing data does not need to be separately uploaded to the log service by each node. Therefore, the system design in which each node strongly depends on the log service is effectively avoided. By using the distributed link tracing data processing method provided in the embodiments of the present disclosure, the data tracing can be performed for the service request, thereby facilitating the quick problem location.

In actual application, due to a problem such as a network delay, the tracing data generated by processing the service request may be abnormal. To prompt that the tracing data of the service request is abnormal, the embodiments of the present disclosure may set preset time to prompt that the tracing data generated by processing the service request is abnormal.

In an optional implementation, the preset time is set for the service node. When the response message fed back by the next-hop service node is not received within the preset time, an abnormality notification is reported to the target storage device, the abnormality notification is used to notify that another tracing data of the service request is lost. The another tracing data may include the tracing data encapsulated in the current response message.

In an optional implementation, when the service request is received, the service request is processed and the first tracing data generated is cached in the local cache, and the sub-request of the service request is constructed and delivered to the next-hop service node.

The second tracing data generated by the next-hop service node through processing the sub-request of the service request and fed back through the response message is received and cached in the local cache.

The next-hop service node may be an intermediate node that processes the service request, and the second tracing data carried in the response message includes tracing data generated by the next-hop service node through processing the sub-request of the service request and tracing data generated by another service node after the next-hop service node through processing another sub-request of the service request. For example, the second tracing data carried in the response message includes tracing data generated by the next-hop service node through processing the sub-request of the service request and tracing data generated by other service nodes after the next-hop service node through respectively processing other sub-requests of the service request.

That is, the second tracing data carried in the response message includes tracing data generated by the current intermediate node when the sub-request of the service request is processed and tracing data generated by another service node after the current intermediate node when another sub-request of the service request is processed.

Then, based on the response message, the response message is processed and the third tracing data generated is cached in the local cache, the first tracing data, the second tracing data, and the third tracing data are obtained from the local cache and spliced to obtain the full link tracing data generated by processing the service request, and the full link tracing data is stored in the target storage device for the link abnormality analysis of the service request.

In another optional implementation, when the service request is received, the service request is processed and the first tracing data generated is cached in the local cache, and the sub-request of the service request is constructed and delivered to the next-hop service node.

The second tracing data generated by the next-hop service node through processing the sub-request of the service request and fed back through the response message is received and cached in the local cache.

The next-hop service node may be a terminal service node that processes the service request, and the terminal service node may specifically be an end service node. The second tracing data in the response message includes tracing data generated by the terminal service node through processing the sub-request of the service request.

That is, the second tracing data carried in the response message includes the tracing data generated by the current terminal service node when the sub-request of the service request is processed.

Then, based on the response message, the response message is processed and the third tracing data generated is cached in the local cache, the first tracing data, the second tracing data, and the third tracing data are obtained from the local cache and spliced to obtain the full link tracing data generated by processing the service request, and the full link tracing data is stored in the target storage device for the link abnormality analysis of the service request.

On the basis of the content of the foregoing embodiments, to prevent the terminal service node from failing to successfully feed back the tracing data to the upper-hop service node, that is, to prevent the tracing data from being lost, in the embodiments of the present disclosure, the tracing data may alternatively be directly stored in the target storage device. Specifically, when it is detected that the second tracing data is not successfully encapsulated in the response message of the terminal service node, the second tracing data is directly stored in the target storage device, and then the second tracing data is obtained from the target storage device to be spliced to obtain the full link tracing data generated by processing the service request.

In actual application, to reduce the storage capacity of the full link tracing data, the embodiments of the present disclosure may alternatively perform data encoding on the tracing data of each node in the full link data generated by processing the service request to implement data compression.

In an optional implementation, the tracing data is encoded and compressed based on a first preset mapping table that stores a character string and an encoding symbol that have a corresponding relationship, and then the encoded and compressed tracing data is cached in the local cache. The character string is a fixed character string in the tracing data.

In an application scenario, when the service request is received, the service request is executed, and the first tracing data generated by executing the service request is obtained. The character string in the first tracing data is mapped to the corresponding encoding symbol based on the first preset mapping table to obtain the encoded first tracing data, and the encoded first tracing data is cached in the local cache.

Similarly, for the tracing data generated on another service node of the service request, the same encoding method may be used to map the character string in the tracing data to the corresponding encoding symbol, and then the encoding symbol is cached in the local cache.

In actual application, the tracing data generated by executing the service request further includes a non-fixed character string, that is, a finite change character string. In the embodiments of the present disclosure, the encoding value corresponding to the character string may be obtained based on a second preset mapping table to compress the data volume.

In an optional implementation, the tracing data is encoded and compressed based on a second preset mapping table that stores a character string and an encoding value that have a corresponding relationship, and then the encoded and compressed tracing data is cached in the local cache, the encoding value is obtained by performing encoding processing based on the corresponding character string.

In an application scenario, the encoding value corresponding to the character string in the first tracing data generated by executing the service request is queried in the second preset mapping table based on the second preset mapping table, the character string in the first tracing data is replaced with the corresponding encoding value to obtain the encoded first tracing data, and the encoded first tracing data is cached in the local cache.

In another optional implementation, when the encoding value corresponding to the character string in the tracing data is not found in the second preset mapping table, the character string may be converted into the corresponding encoding value based on an encoding mode corresponding to the second preset mapping table to obtain the encoded tracing data, and the corresponding relationship between the character string and the encoding value is stored in the second preset mapping table.

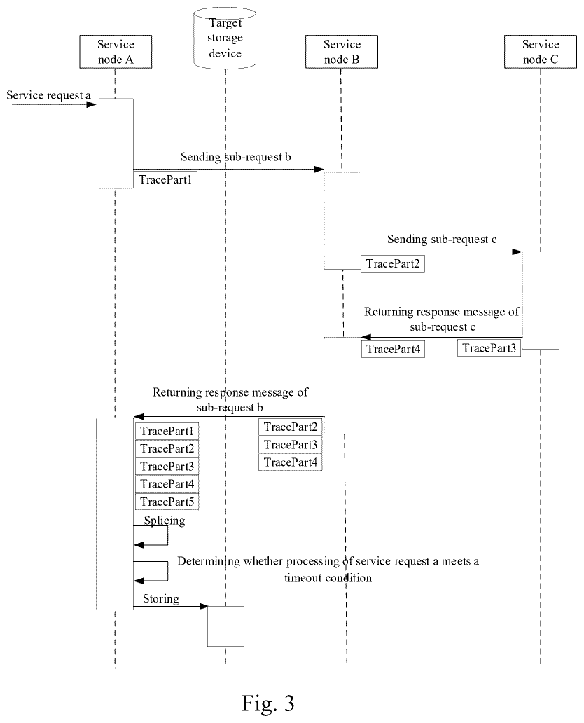

To facilitate understanding of the content of the foregoing embodiments, the distributed link tracing data processing method provided in the present disclosure is described by using a distributed I/O system as an example. FIG. 3 is a schematic diagram of a process of distributed link tracing data processing according to an embodiment of the present disclosure.

Firstly, when the service node A receives the processing instruction of the service request a, the service node A processes the service request a, that is, executes related processing logic, and caches the tracing data TracePart1 generated by processing the service request a in the local cache. The tracing data TracePart1 is partial tracing data on the tracing link of the service request a.

Then, the sub-request b of the service request a is constructed, the tracing identification corresponding to the service request a is encapsulated in the sub-request b, and the sub-request b is sent to the service node B. When receiving the sub-request b of the service request a, the service node B processes the sub-request b, and caches the tracing data TracePart2 generated by processing the sub-request b in the local cache. The tracing data TracePart2 is partial tracing data on the tracing link of the service request a.

Then, the sub-request c of the service request a is constructed, the tracing identification corresponding to the service request a is encapsulated in the sub-request c of the service request a, and the sub-request c of the service request a is sent to the service node C. When receiving the sub-request c, the service node C processes the sub-request c, and caches the tracing data TracePart3 generated by processing the sub-request c in the local cache. When the service node C finishes processing the related logic of the sub-request c, the tracing data TracePart3 is encapsulated in the response message of the sub-request c, and the response message of the sub-request c of the service request a is returned to the service node B.

When the service node B receives the response message of the sub-request c, the service node B obtains the tracing data TracePart3 generated by processing the sub-request c from the response message and caches the tracing data TracePart3 in the local cache. The service node B processes related logic based on data in the response message and caches the tracing data TracePart4 generated by processing the response message in the local cache. Then, the tracing data TracePart2, TracePart3, and TracePart4 are obtained from the local cache of the service node B, and the foregoing tracing data TracePart2, TracePart3, and TracePart4 are encapsulated in the response message returned to the service node A, and the response message of the sub-request b of the service request a is returned to the service node A.

When the service node A receives the response message of the sub-request b, the service node A obtains the tracing data TracePart2, TracePart3, and TracePart4 from the response message and caches the tracing data TracePart2, TracePart3, and TracePart4 in the local cache. The service node A processes related logic based on data in the response message and caches the tracing data TracePart5 generated by processing the response message in the local cache.

The service node A obtains the tracing data TracePart1, TracePart2, TracePart3, TracePart4, and TracePart5 generated by processing the service request a from the local cache, splices the tracing data to obtain the full link tracing data generated by processing the service request a, determines, based on the full link tracing data, whether the processing of the service request a meets the timeout condition, and when the processing of the service request a meets the timeout condition, stores the full link tracing data in the target storage device. The processing logic for the service request a ends.

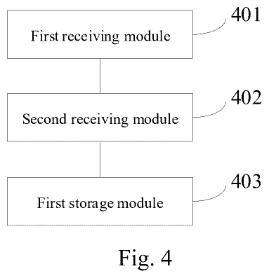

To implement the foregoing embodiments, the present disclosure further provides a distributed link tracing data processing apparatus. FIG. 4 is a schematic structural diagram of a distributed link tracing data processing apparatus according to an embodiment of the present disclosure. The apparatus may be implemented by software and/or hardware, and may generally be integrated into an electronic device. As shown in FIG. 4, the apparatus includes:
a first receiving module 401, configured to receive a service request, process the service request and cache first tracing data generated in a local cache, and construct a sub-request of the service request and deliver the sub-request to a next-hop service node;
a second receiving module 402, configured to receive second tracing data generated by the next-hop service node through processing the sub-request of the service request and fed back by the next-hop service node through a response message, and cache the second tracing data in the local cache; and
a first storage module 403, configured to process the response message and cache third tracing data generated in the local cache, obtain the first tracing data, the second tracing data, and the third tracing data from the local cache, splice the first tracing data, the second tracing data, and the third tracing data to obtain full link tracing data generated by processing the service request, and store the full link tracing data in a target storage device for link abnormality analysis of the service request.

In an optional implementation, the first receiving module includes a construction module. The construction module is configured to:
construct the sub-request of the service request, and encapsulate a tracing identification of the service request in the sub-request, in which the tracing identification is delivered with a processing path of the service node, and the tracing identification is used to identify tracing data related to the service request.

In an optional implementation, the apparatus further includes:
a determining module, configured to determine, based on the full link tracing data, whether processing of the service request meets a timeout condition; and
a second storage module, configured to: when it is determined that the processing of the service request meets the timeout condition, store the full link tracing data in the target storage device.

In an optional implementation, the next-hop service node is an intermediate node that processes the service request, and the second tracing data in the response message includes tracing data generated by the next-hop service node through processing the sub-request of the service request and tracing data generated by another service node after the next-hop service node through processing another sub-request of the service request.

In an optional implementation, the apparatus further includes:
a reporting module, configured to: when the response message fed back by the next-hop service node is not received within preset time, report an abnormality notification to the target storage device, in which the abnormality notification is used to notify that another tracing data of the service request is lost.

In an optional implementation, the next-hop service node is a terminal service node that processes the service request, and the second tracing data in the response message includes tracing data generated by the terminal service node through processing the sub-request of the service request.

In an optional implementation, the terminal service node is configured to: directly store, in the target storage device, tracing data that is not successfully fed back to an upper-hop service node, in which the tracing data is used to be spliced to obtain the full link tracing data generated by processing the service request.

In an optional implementation, the apparatus further includes:
a first encoding module, configured to: encode and compress the tracing data based on a first preset mapping table that stores a character string and an encoding symbol that have a corresponding relationship, and then cache the encoded and compressed tracing data in the local cache.

In an optional implementation, the apparatus further includes:
a second encoding module, configured to: encode and compress the tracing data based on a second preset mapping table that stores a character string and an encoding value that have a corresponding relationship, and then cache the encoded and compressed tracing data in the local cache, in which the encoding value is obtained by performing encoding processing based on the corresponding character string.

In the distributed link tracing data processing apparatus provided in the embodiments of the present disclosure, a service request is received, the service request is processed and first tracing data generated is cached in a local cache, a sub-request of the service request is constructed and delivered to a next-hop service node, second tracing data generated by the next-hop service node through processing the sub-request of the service request and fed back through a response message is received and cached in the local cache, the response message is processed and third tracing data generated is cached in the local cache, the first tracing data, the second tracing data, and the third tracing data are obtained from the local cache and spliced to obtain full link tracing data generated by processing the service request, and the full link tracing data is stored in a target storage device for link abnormality analysis of the service request.

According to the embodiments of the present disclosure, the first tracing data generated by processing the service request is cached in the local cache, the second tracing data generated by the next-hop service node through processing the sub-request of the service request and fed back through the response message is cached in the local cache, and the third tracing data generated by processing the response message is cached in the local cache, so that the full link tracing data generated by processing the service request is stored in a unified manner at the same node, and the tracing data does not need to be separately uploaded to the log service by each node. Therefore, the system design in which each node strongly depends on the log service is effectively avoided. By using the distributed link tracing data processing method provided in the embodiments of the present disclosure, the data tracing can be performed for the service request, thereby facilitating the quick problem location.

The distributed link tracing data processing apparatus provided in the embodiments of the present disclosure can perform the distributed link tracing data processing method provided in any embodiment of the present disclosure, and has function modules and beneficial effects corresponding to the method execution.

To implement the foregoing embodiments, the embodiments of the present disclosure further provide a computer program product. The computer program product includes a computer program/instruction. When the computer program/instruction is executed by a processor, the distributed link tracing data processing method in the foregoing embodiment is implemented.

In addition to the foregoing method and apparatus, the embodiments of the present disclosure further provide a computer-readable storage medium. The computer-readable storage medium stores instructions, and when the instructions are run on a terminal device, the terminal device is enabled to implement the distributed link tracing data processing method according to the embodiments of the present disclosure.

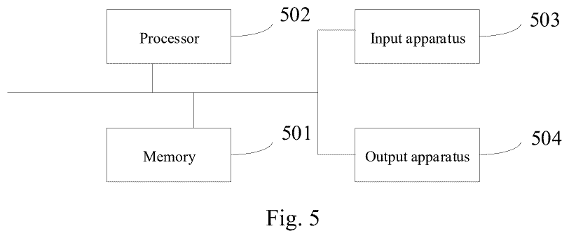

In addition, the embodiments of the present disclosure further provide a distributed link tracing data processing device. As shown in FIG. 5, the device may include:

a processor 501, a memory 502, an input apparatus 503, and an output apparatus 504. One or more processors 501 may be provided in the distributed link tracing data processing device. FIG. 5 shows one processor as an example. In some embodiments of the present disclosure, the processor 501, the memory 502, the input apparatus 503, and the output apparatus 504 may be connected through a bus or in another manner. FIG. 5 shows the connection through the bus as an example.

The memory 502 may be configured to store a software program and modules. The processor 501 may perform various functional applications and data processing of the distributed link tracing data processing device by running the software program and modules stored in the memory 502. The memory 502 may mainly include a program storage region and a data storage region. The program storage region may store an operating system, an application required for at least one function, and the like. In addition, the memory 502 may include a high-speed random access memory, and may also include a non-volatile memory, for example, at least one magnetic disk storage device, a flash memory device, or another volatile solid-state storage device. The input apparatus 503 may be configured to receive input digital or character information and generate signal input related to user settings and function control of the distributed link tracing data processing device.

Specifically, in this embodiment, the processor 501 loads, into the memory 502, an executable file corresponding to a process of one or more applications according to the following instructions, and the processor 501 runs the application stored in the memory 502, to implement various functions of the distributed link tracing data processing device described above.

It should be noted that relational terms such as “first” and “second” are used herein only to distinguish between one entity or operation and another entity or operation, and are not necessarily intended to require or imply any actual relationship or order between these entities or operations. Moreover, the term “include/comprise” or any other variation thereof is intended to cover a non-exclusive inclusion, such that a process, method, article, or device that includes a list of elements includes not only those elements but also other elements not expressly listed, or elements that are inherent to such a process, method, article, or device. Without more limitations, an element defined by a statement “include/comprise one.. .” does not exclude that there are other same elements in the process, method, article, or device that includes the element.

The above are only specific implementations of the present disclosure, and enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure is not limited to these embodiments described herein, but is to be accorded the widest scope consistent with the principles and novel features disclosed herein.

1. A distributed link tracing data processing method, comprising:
receiving a service request, processing the service request, and caching first tracing data generated in a local cache, and constructing a sub-request of the service request and delivering the sub-request to a next-hop service node;
receiving second tracing data generated by the next-hop service node through processing the sub-request of the service request and fed back by the next-hop service node through a response message, and caching the second tracing data in the local cache; and
processing the response message and caching third tracing data generated in the local cache, obtaining the first tracing data, the second tracing data, and the third tracing data from the local cache, splicing the first tracing data, the second tracing data, and the third tracing data to obtain full link tracing data generated by processing the service request, and storing the full link tracing data in a target storage device for link abnormality analysis of the service request.

2. The method according to claim 1, wherein the constructing the sub-request of the service request comprises:
constructing the sub-request of the service request, and encapsulating a tracing identification of the service request in the sub-request, wherein the tracing identification is delivered with a processing path of a service node, and the tracing identification is used to identify tracing data related to the service request.

3. The method according to claim 1, wherein before the storing the full link tracing data in the target storage device, the method further comprises:
determining, based on the full link tracing data, whether processing of the service request meets a timeout condition; and
when it is determined that the processing of the service request meets the timeout condition, storing the full link tracing data in the target storage device.

4. The method according to claim 1, wherein the next-hop service node is an intermediate node that processes the service request, and the second tracing data in the response message comprises: tracing data generated by the next-hop service node through processing the sub-request of the service request and tracing data generated by another service node after the next-hop service node through processing another sub-request of the service request.

5. The method according to claim 1, further comprising:
in response to that the response message fed back by the next-hop service node is not received within preset time, reporting an abnormality notification to the target storage device, wherein the abnormality notification is used to notify that another tracing data of the service request is lost.

6. The method according to claim 1, wherein the next-hop service node is a terminal service node that processes the service request, and the second tracing data in the response message comprises tracing data generated by the terminal service node through processing the sub-request of the service request.

7. The method according to claim 6, wherein the terminal service node is configured to: directly store, in the target storage device, tracing data that is not successfully fed back to an upper-hop service node, wherein the tracing data is used to be spliced to obtain the full link tracing data generated by processing the service request.

8. The method according to claim 1, wherein before the caching in the local cache, the method further comprises:
encoding and compressing the tracing data based on a first preset mapping table that stores a character string and an encoding symbol that have a corresponding relationship, and then caching encoded and compressed tracing data in the local cache.

9. The method according to claim 1, wherein before the caching in the local cache, the method further comprises:
encoding and compressing the tracing data based on a second preset mapping table that stores a character string and an encoding value that have a corresponding relationship, and then caching encoded and compressed tracing data in the local cache, wherein the encoding value is obtained by performing encoding processing based on a corresponding character string.

10. An electronic device, comprising:
a processor; and
a memory, configured to store an instruction executable by the processor,
wherein the processor is configured to: read the instruction from the memory, and execute the instruction to
receive a service request, process the service request, and cache first tracing data generated in a local cache, and construct a sub-request of the service request and deliver the sub-request to a next-hop service node;
receive second tracing data generated by the next-hop service node through processing the sub-request of the service request and fed back by the next-hop service node through a response message, and cache the second tracing data in the local cache; and
process the response message and cache third tracing data generated in the local cache, obtain the first tracing data, the second tracing data, and the third tracing data from the local cache, splice the first tracing data, the second tracing data, and the third tracing data to obtain full link tracing data generated by processing the service request, and store the full link tracing data in a target storage device for link abnormality analysis of the service request.

11. The electronic device according to claim 10, wherein the processor is further to:
construct the sub-request of the service request, and encapsulate a tracing identification of the service request in the sub-request, wherein the tracing identification is delivered with a processing path of a service node, and the tracing identification is used to identify tracing data related to the service request.

12. The electronic device according to claim 10, wherein the processor is further to:
determine, based on the full link tracing data, whether processing of the service request meets a timeout condition; and
when it is determined that the processing of the service request meets the timeout condition, store the full link tracing data in the target storage device.

13. The electronic device according to claim 10, wherein the next-hop service node is an intermediate node that processes the service request, and the second tracing data in the response message comprises: tracing data generated by the next-hop service node through processing the sub-request of the service request and tracing data generated by another service node after the next-hop service node through processing another sub-request of the service request.

14. The electronic device according to claim 10, wherein the processor is further to:
in response to that the response message fed back by the next-hop service node is not received within preset time, report an abnormality notification to the target storage device, wherein the abnormality notification is used to notify that another tracing data of the service request is lost.

15. The electronic device according to claim 10, wherein the next-hop service node is a terminal service node that processes the service request, and the second tracing data in the response message comprises tracing data generated by the terminal service node through processing the sub-request of the service request.

16. The electronic device according to claim 15, wherein the terminal service node is configured to:
directly store, in the target storage device, tracing data that is not successfully fed back to an upper-hop service node, wherein the tracing data is used to be spliced to obtain the full link tracing data generated by processing the service request.

17. The electronic device according to claim 10, wherein the processor is further to:
encode and compress the tracing data based on a first preset mapping table that stores a character string and an encoding symbol that have a corresponding relationship, and then cache encoded and compressed tracing data in the local cache.

18. The electronic device according to claim 10, wherein the processor is further to:
encode and compress the tracing data based on a second preset mapping table that stores a character string and an encoding value that have a corresponding relationship, and then cache encoded and compressed tracing data in the local cache, wherein the encoding value is obtained by performing encoding processing based on a corresponding character string.

19. A non-transitory computer-readable storage medium, storing a computer program, wherein the computer program is executable by a process to:
receive a service request, process the service request, and cache first tracing data generated in a local cache, and construct a sub-request of the service request and deliver the sub-request to a next-hop service node;
receive second tracing data generated by the next-hop service node through processing the sub-request of the service request and fed back by the next-hop service node through a response message, and cache the second tracing data in the local cache; and
process the response message and cache third tracing data generated in the local cache, obtain the first tracing data, the second tracing data, and the third tracing data from the local cache, splice the first tracing data, the second tracing data, and the third tracing data to obtain full link tracing data generated by processing the service request, and store the full link tracing data in a target storage device for link abnormality analysis of the service request.

20. The medium according to claim 19, wherein the computer program is executable by a process to:
construct the sub-request of the service request, and encapsulate a tracing identification of the service request in the sub-request, wherein the tracing identification is delivered with a processing path of a service node, and the tracing identification is used to identify tracing data related to the service request.
